(19) United States
(12) Patent Application Publication
(10) Pub. No.: US 2015/0233463 A1
(43) Pub. Date: Aug. 20, 2015

(54) DEVICE FOR SEALING AN OPENING OF AN ENCLOSURE WALL FOR ACCESS TO A ROTARY SHAFT

(71) Applicant: SNECMA, Paris (FR)

(72) Inventor: Jean-Pierre Elie Galivel, Paris (FR)

(73) Assignee: SNECMA, Paris (FR)

(21) Appl. No.: 14/426,125

(22) PCT Filed: Sep. 5, 2013
(86) PCT No.: PCT/FR2013/052050

§ 371 Date: Mar. 4, 2015

(30) Foreign Application Priority Data
Sep. 7, 2012 (FR) 1258366

(51) Int. Cl. F16H 57/031; F01D 25/24

(52) U.S. Cl. CPC F16H 57/031; F01D 25/24

(57) ABSTRACT

The invention relates to a device for sealing an opening of an enclosure wall for access to a rotary shaft. The device is capable of being sealingly inserted in said opening and of being secured against the wall by securing elements. The device includes two cylindrical parts assembled slidably relative to one another, coaxially relative to the opening: a first part capable of being statically inserted in the opening, and a second part capable of being secured to the wall by the securing elements and subjected to the action of a resilient means provided between the parts and tending to axially separate the second part from the wall.

The present invention relates to a device for sealing an opening provided in a wall of an enclosure and permitting access, for inspection purposes, to a rotary shaft housed therein. It relates, in a particular though not exclusive application, to an enclosure of a gearbox of the type intended for driving accessory equipment in a turboshaft engine, such as a turbojet engine, the box comprising a shaft for the manual driving of the gears permitting rotation of the rotor during maintenance operations on the engine. The shaft being accessible from outside the box, a removable sealing device closes off the passage during operation when maintenance is not underway.

It is known that an aeronautic turboshaft engine, turbojet engine or turboprop engine comprises accessory or auxiliary equipment: pumps, alternators and the like, which are generally driven mechanically by drive shafts, in particular by the shaft of the HP rotor. According to a conventional use, the accessories are mounted on an equipment support. The support, which is commonly referred to by its English abbreviation AGB, standing for “accessory gear box”, comprises a box incorporating a mechanism formed of pinions with parallel axes, said pinions meshing with one another. The pinions are driven by an input shaft, which is itself connected by a kinematic chain to a shaft of the turboshaft engine. The accessories are thus mounted in parallel on the support while being coupled mechanically to the pinions by which they are driven. Lubrication of the pinions is provided by a circulation of oil inside the gearbox.

One of the pinions is not used for driving any accessory equipment; it serves mainly for the manual rotation of the rotor during inspection and servicing of the turboshaft engine. The AGB thus comprises an opening or passage giving access to a shaft carrying this pinion from the outside by a drive member. This opening is closed off, sealingly, by a sealing device when the engine is not being serviced.

The device generally comprises a single-piece cylindrical body provided, at its periphery, with O-ring seals engaging with the internal surface or periphery delimiting the opening in the wall. At the external exit of the opening, the body extends radially through a transverse collar forming the cover and which rests against the wall in order to be secured thereto by securing elements such as screws.

This device is removed when inspection of the engine requires access to this pinion and therefore to the shaft, with removal of the screws and axial extraction of the sealing device. After inspection of the shaft (with rotation thereof by the drive member of the crank type or the like), the sealing device is replaced by introducing the body with the sealing joints into the opening and then bolting the cover on the wall of the box, before the engine is started.

To ensure the safety of aeronautic machines, it is, however, essential to take into account the eventuality of the cover not being correctly reassembled or simply being forgotten. If this were to occur, during operation, the oil lubricating the mechanical members of the box would escape through the opening with the inevitable consequence of the engine coming to a stop.

In addition, in the case that concerns us, an internal oil pipe opens into the periphery of the opening in an external recess in the body, delimited by O-ring seals.

Thus, if inadvertently the sealing device is not installed, as soon as the engine is started, a low-pressure alarm in the oil circuit is triggered and then a large amount of the oil escapes to the outside through the pipe and then to the open air, which makes it possible to quickly identify the problem and to stop the engine before this results in disastrous consequences for the aircraft.

However, the cover of the sealing device may be installed in the opening without the screws, that is to say with the body and sealing joints engaged in the opening and the cover pressed against the wall. Thus the device may be held in place in the opening by friction forces between the O-ring seals and the internal periphery of the opening.

In this case, when the engine is operating on the ground at slow speed, it is improbable that the sealing device would be ejected, so that the low-pressure alarm does not detect anything. However, the risk of not detecting incorrect assembly, without the screws, is patent, and in particular before the takeoff or cruising phases with an engine under full load, and therefore an oil circuit pressurised to the maximum, undoubtedly causing ejection of the sealing device. Such a situation would cause the engine to stop at an inopportune moment and must therefore be absolutely avoided.

The case can also be envisaged where the screws are indeed mounted but insufficiently tightened, so that a clearance may appear between the cover of the body of the device and the wall of the enclosure, with oil quickly being lost when the engine is in operation.

The object of the present invention is to remedy these drawbacks by eliminating the problems related in particular to the absence of the securing elements after reassembly of the sealing device.

For this purpose, the device for sealing an opening provided in the wall of an enclosure and permitting access to a rotary shaft, said device being capable of being sealingly inserted in said opening and of being secured against the wall by securing elements, is characterised in that it comprises two cylindrical parts assembled slidably with respect to each other, coaxially relative to the opening, a first part capable of being statically inserted in the opening, and a second part capable of being secured to the wall by the securing elements and subjected to the action of a resilient means provided between the assembled parts and tending to axially separate the second part from the wall.

Thus, unlike a sealing device with a single-piece body, if the securing elements are absent, or even incompletely screwed, the second movable part will be pushed towards the outside of the opening in the wall, by the resilient means assisted in addition by the pressure of the oil when the engine is started. In this way, a space is created between the opening and the second part, giving rise to a significant leakage of oil, which will then inevitably be detected by the usual low-pressure alarm.

Consequently, such a sealing device does away with the aforementioned drawbacks and avoids the risk of operating the engine with a sealing device engaged and poorly secured (without the screws or with non-tightened screws).

In a preferred embodiment, the resilient means is a compression spring that rests on corresponding transverse faces of the first secured part and of the second movable part.

To mark the axially secured position of the first cylindrical part, said part is mounted in axial abutment in the opening.

For example, the first part has an external shoulder capable of resting against an internal shoulder forming an axial stop in said opening.

In particular, said first and second cylindrical parts carry around them sealing joints capable of engaging with the opening (the sealing joint on the first secured part engaging with the internal surface of the opening, and the sealing joint on the second movable part engaging with this internal surface or with the transverse face of the wall delimiting the entrance to the opening), said resilient means being provided in a peripheral space or chamber provided between the sealing joints of said parts. The oil-feed channel issuing from the box or from the enclosure opens into this space between the two sealing joints, when the device is mounted, to allow flow of oil and causes the leakage of oil out of the opening when the second movable part is pushed from the opening by the resilient means, as a result of the absence or insufficient screwing of the securing elements.

In a preferred embodiment, the second movable cylindrical part is mounted sealingly in part between the first secured part and the internal surface of the opening, and terminates in a radial collar forming a cover capable of being attached against the wall of the enclosure by the securing elements.

Advantageously, the second part is mounted around the first part and can be moved axially between an external shoulder of the first part and a stop part rigidly connected to the first part. Thus it remains connected to said first part and its axial movement, under the action of the resilient means, is moreover limited and sufficient to cause significant leakage.

For example, the stop part is screwed into a threaded passage in the first secured part and has an external transverse ledge forming an axial stop for the second movable part.

The invention also relates to a gearbox forming an enclosure supporting the accessory machines of a turboshaft engine, comprising an external wall in which there is provided an opening for access to a shaft for the manual driving of a rotor of the turboshaft engine or of an accessory machine, and a device for sealing said access opening.

Advantageously, said sealing device is as described above.

Other features and advantages will become apparent upon reading the detailed description of a non-limiting embodiment of the invention with reference to the drawings, in which:

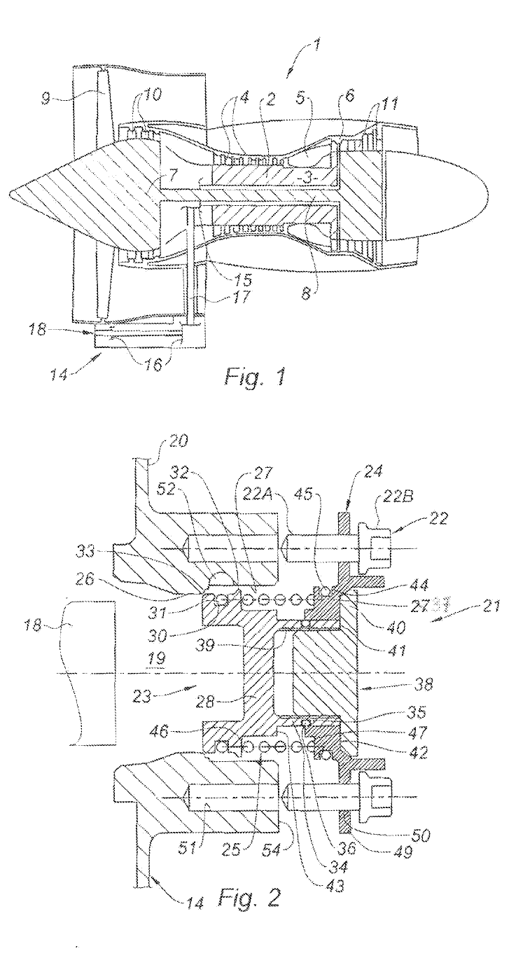

FIG. 1 is the diagram of a turboshaft engine to which the solution of the invention applies;

FIG. 2 is a longitudinal section of the sealing device according to the invention before mounting thereof in the opening of an enclosure permitting access to a rotary shaft;

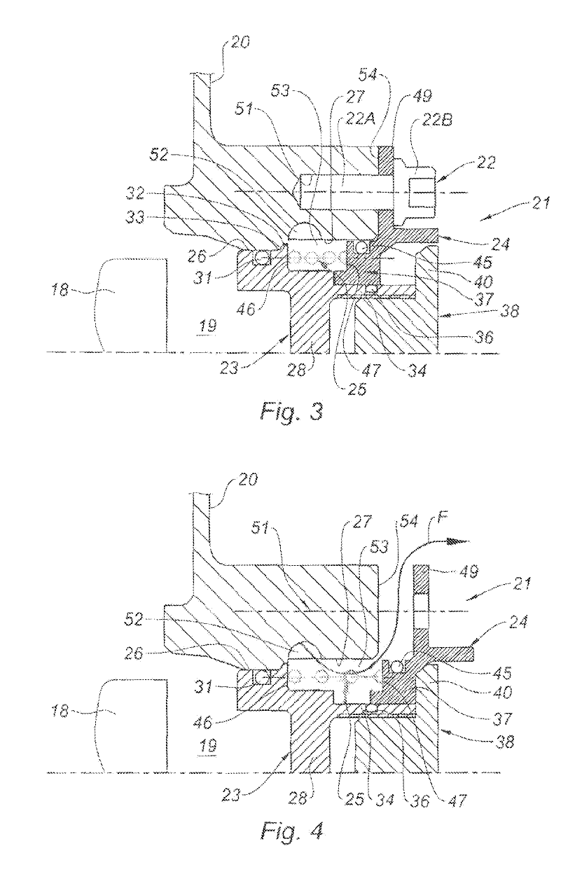

FIG. 3 is a longitudinal half-section of the sealing device mounted in the opening and secured correctly to the wall of the enclosure; and

FIGS. 4, 5 and 6 are longitudinal half-sections of the sealing device mounted, respectively, without the securing screws, with faulty replacement of the screws and with the screws having been forgotten to be tightened with a tool.

Referring to FIG. 1, a turboshaft engine 1 can be seen, in this case a twin spool bypass turbojet engine. It commonly comprises a high-pressure rotor 2 with successively, from upstream to downstream, a high-pressure compressor 4, a combustion chamber 5 and a turbine 6; said turbine is connected by a shaft 3 to the compressor that it drives. The low-pressure rotor 7 comprises the fan 9 upstream and the low-pressure compressor 10 upstream of the high-pressure rotor; the two are connected by a low-pressure shaft 8 to the turbine 11 downstream of the high-pressure turbine 6.

An equipment support 14, forming a box or enclosure, is mounted on the external collar of the fan casing or of the intermediate casing. This support contains the accessory equipment of the engine, such as the fuel and oil pumps and the electrical generators. This equipment is driven by pinions 16 housed in the box 14, to which they are coupled by suitable connections. These pinions 16 mesh with one another and are themselves moved by a kinematic chain consisting of a plurality of transmission shafts 17 between the box 14 and the conical pinions 15 of an angle gearbox on the shaft 3 of the high-pressure rotor.

Referring to FIG. 2, this shows the end of a shaft 18 that is accessible from the outside of the box 14 through an opening 19, which may for example be circular, provided in the wall 20 of the box, coaxially with the shaft.

The end of the shaft 18 is shaped so as to allow the engagement of a tool for the manual rotation of the pinions 16 (one of said pinions, which is not shown, being rigidly connected to the shaft 18) of the shafts 17 and of the kinematic chain during inspections of the high-pressure rotor of the engine.

When said engine is not being maintained, the opening 19 is closed off by a plugging or sealing device 21 that is secured removably by securing elements 22 to the wall of the box.

The device 21 for sealing the opening that is provided in the wall 20 of the box 14, for accessing the rotary shaft 18, comprises, as shown in FIG. 2, two cylindrical main parts 23 and 24 assembled so as to slide with respect to each other with a resilient means 25 between them, tending to separate or move them axially away from each other.

In the application of the invention, the first part 23 is intended to engage with axial abutment in the first bore 26 of the opening 19, being held therein statically, as will be seen subsequently. And the second part 24 is mounted in part around the first part and is intended to also engage in the opening but in a bore 27 with a greater diameter than the first bore, opening into the outside of the box, in order to be secured to the wall 20 by securing elements such as screws 22.

In particular, the first cylindrical part 23 forming a seal comprises a transverse bottom 28 closing off the opening 19 and at the periphery 29 of which a groove 30 is provided for receiving an 0-ring seal 31. An external annular shoulder 32 is also provided at this periphery and is capable of coming into axial abutment against an internal annular shoulder 33 provided at the change in cross sections of the two bores 26, 27 of the opening.

The transverse bottom 28 is extended, on the side opposite to the shaft, by an annular lateral wall 34 that comprises at its periphery a groove 35 for receiving an O-ring seal 36.

Around the lateral wall 34 of the first part 23, the annular lateral wall 37 of the second part 24 is mounted. To prevent said second part coming out with respect to the first part, a stop part 38 is provided. Said stop part is mounted by screwing in a central threaded hole 39 that is delimited by the lateral wall 34 of the first part until it rests, by an external transverse ledge 40 on the part 38, against the corresponding transverse face 41 of the lateral wall 34 of the first part.

The transverse ledge 40 projects radially from said first part so that the second annular part 24, previously mounted on the lateral wall of the first part, is pushed, under the action of the resilient means, such as a compression spring 25, in axial abutment against the transverse ledge 40 of the part 39, against which the external transverse face 42 of the second part 24 rests. The second part can thus slide between this stop position and another position, with the spring compressed, in the direction of an external transverse shoulder 43 on the lateral wall 34, following the screwing of the screws, as will be seen below.

Moreover, at the external periphery of the lateral wall 37 of the second part there is a groove 44 in which an O-ring seal 45 is received, said O-ring seal being capable of engaging with the surface of the second bore 27.

As for the compression spring 25, this surrounds the parts 23, 24 and rests firstly against a transverse face 46 provided in the periphery 29 of the bottom and from which there issues the shoulder 32 of the first part for abutment against the opening, and, secondly against a transverse face 47 of the annular wall 37 of the second part.

When the two parts of the sealing device 21 are assembled, the spring is situated between the joints 31, 45 with the parts which have a tendency to separate spontaneously through the spring 25, pushing the second part 24 against the transverse ledge 40 on the stop part 38, the wall 37 of the second part engaging with the sealing joint 36 of the first part.

It is seen moreover that the annular wall 37 of the second part extends transversely through a collar or base 49 in which, distributed regularly, holes 50 are provided for passage of the threaded rods 22A of the securing screws 22.

The approach of the sealing device 21 thus assembled, with regard to the opening 19 in the box 14, is shown in FIG. 2.

The wall 20 of the box comprises, around the opening 19, threaded holes 51 for receiving the rods of the screws 22 and, conventionally, the oil-feed pipe or channel 52 firstly in communication with the inside of the box 14 in which the shaft 18 is situated and secondly opening into the bore 27 as shown in FIGS. 2 to 6.

The mounting itself of the device 21 in the opening 19 does not raise any difficulties.

As shown in FIG. 3, the first cylindrical part 23 of the device is engaged in the opening with the O-ring seal 31, at the external periphery 29 of the bottom, in contact with the surface delimiting the first bore 26, an engagement that continues until the external shoulder 32 of the first part comes into contact against the internal shoulder 33 of the opening.

Then the clamping screws 22 are mounted for securing the collar 49 of the second cylindrical part 24 against the external transverse face 54 of the wall, the rods 22A being screwed into the threaded holes 51 in the wall until the heads 22B of the screws come into contact against the collar, which itself is against the wall.

Simultaneously, as the first part 23 is in axial abutment against the box, the screwing has caused the second part 24 to slide towards the first part with compression of the spring 25, and the wall 37 to approach the shoulder 43 of the first axially secured part. During the sliding, the external sealing joint 45 on the movable second part 24 has come into contact with the surface delimiting the second bore 27, while the wall 37 of the second annular part is still in contact with the sealing joint 36 of the lateral wall 34 of the first part 23. The second part 24 is thus distant from the transverse ledge 40 forming the stop for the part 38. In a variant embodiment that is not shown, it can be envisaged arranging the sealing joint 45 between the collar 49 and the transverse face 54 of the wall. In this case, the O-ring seal in FIG. 3 will be replaced by a flat seal, the sealing being provided by the complete tightening of the screws 22.

The internal chamber or space 53 in which the spring 25 is situated and which is delimited by the transverse faces 46 and 47 of the parts and the surface of the bore 27 is in communication with the oil pipe 52, while being made impervious vis-à-vis the outside by the various sealing joints.

In the representation shown in FIG. 3, the opening 19 is suitably closed off by the sealing device 21 by the O-ring seals 31, 36, 45, so that the engine can operate in complete safety. The low-pressure alarm remains inactive since it does not detect any drop in pressure in the box.

The shaft is thus isolated sealingly from the outside.

It is now supposed that, after removal of the sealing device 21 and inspection of the shaft 18 and the associated mechanisms, the device is returned to the opening 19 in the position shown in FIG. 4. The device is certainly engaged in the opening with the sealing joint 31 of the first part in contact with the internal surface of the bore 26, but the second part remains outside the opening as a result of the action of the compression spring.

Such a position occurs when the clamping screws 22 are not reset place in due to an oversight by the operator.

Advantageously, the design of the device 21 in two parts that are axially movable through a resilient means makes it possible to hold the second part outside and at a distance from the opening 19, creating sufficient space between the wall of the second part 24 and the entrance to the opening 19 (bore 27). This is because, through the action of the spring 25, the second part 24 is spontaneously pushed against the ledge 40 of the part 38.

In this way, as soon as the engine is started, a massive leakage of oil occurs as a result of the oil emerging from the channel 32 in order to go into the chamber 53 and escape out of the box 14 by way of the opening through the annular space created, as shown by the arrow F.

This total loss of seal results in a drop in pressure in the box, which is immediately detected by the low-pressure alarm.

The second part 24 is held outwards under the effect of the spring and the internal pressure of the oil escaping through the channel. The device 21 thus perfectly fulfils its safety role by establishing a quickly detectable significant oil leakage.

In the view in FIG. 5, the mounting of the screws 22 in the threaded holes 51 is effective but the complete locking or screwing of said screws is not achieved. A very small space appears between the collar 49 of the movable part 24 and the transverse face 54 of the wall 20 of the box.

The axial movement of the second part 24 by the heads 22B of the screws has caused the compression of the spring 25 with the wall 37 of the part 24 moving towards the shoulder 43 of the secured part 23, and has allowed the sealing joint 45 to be placed in the second bore 27, so as to ensure a seal vis-à-vis the outside. The oil (arrow F) leaving the channel 52 cannot leak towards the outside of the opening through the device 21 because of the presence of the sealing joints 36 and 45.

To avoid an incomplete reassembling of the screws of this type, it is necessary to use screw locking devices 55 introduced into the bottom of the threaded holes 51 of the screws so that, once the screws are tightened by hand, that is to say before the threaded rods 22A engage with the locking devices 55, the sealing joint 45 of the second movable part 24 of the device is still at a distance from the entrance to the second bore 27. The purpose of these screw locking devices is to prevent the second part approaching and therefore to prevent the impermeability of the sealing joint that is associated with the opening, other than through the use of a specific tightening tool guaranteeing the tightening of the screws in the locking devices and the correct mounting of the sealing device with impermeability.

Thus it is possible to determine or calculate the axial position of the screw locking devices with respect to the length of the screws tightened manually so that said screws provide the correct tightening with sealing of the device only after having been screwed by means of a specific tool. The second part 24 (collar 49) cannot therefore be moved close to the wall 20 (transverse face 54) other than with the use of the specific tool, which provides a guarantee of tightening of the screws.

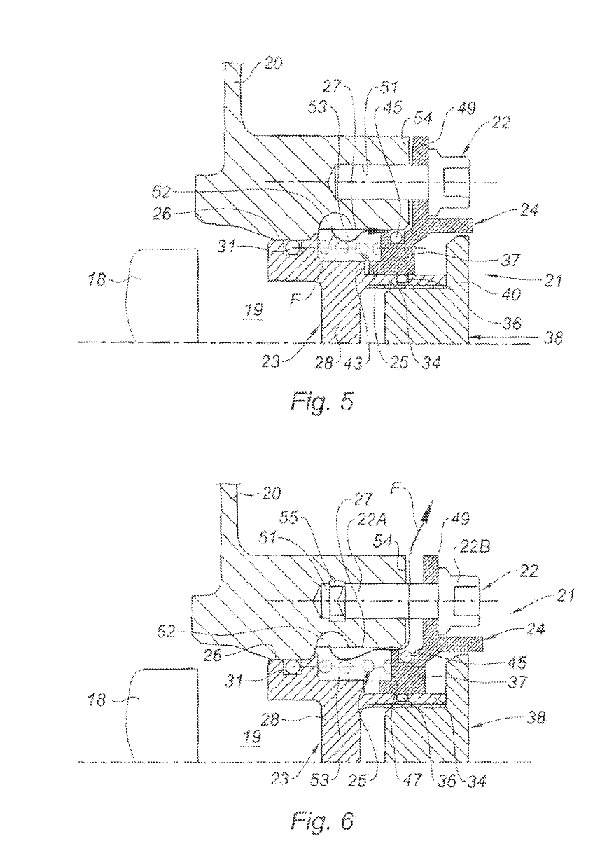

As shown in FIG. 6, the screw locking devices 55 are rings housed in the bottom of the threaded holes and produced from a suitable material for engagement of the threaded rods of the screws by a tightening tool.

In this drawing, the screws 22 have been mounted by hand in the threaded holes 51 in the wall as far as the level of the rings 55 (coming into abutment against said rings), where only the use of a tool makes it possible to continue the tightening of the screws to the required torque with fitting of the sealing joint 45. If the operator forgets to tighten the screws by means of the tool and leaves the sealing device 1 in the position shown, the sealing joint 45 of the movable part 24 is still axially distant from the entrance to the bore 27, with the part subjected to the action of the spring 25 tending to move it away outwards, in this case against the heads 22B of the screws.

Thus, if the engine is started, a significant leakage of oil issuing from the channel 52 and passing through the chamber 53 (and therefore the opening) occurs immediately towards the outside of the box in the direction of the arrow F in FIG. 6. This leakage simultaneously causes a drop in pressure in the box, which is detected by the low-pressure alarm. Here, too, the leakage created by the sealing device of the invention means that in the event of the incorrect tightening of the screws having been overlooked, it is inevitable that said incorrect tightening will be detected. Only the final tightening of the screws in the rings with a suitable tool will ensure that the device in the opening is correctly sealed, as shown in FIG. 3.

Unlike the conventional, static, single-piece devices, the device according to the invention has two parts, one of which is made movable with a piston effect (by means of the spring that is assisted by the oil pressure), when the operator forgets to replace the screws or replaces them incompletely, creating a quickly detectable significant leakage.

1. Device for sealing an opening provided in the wall of an enclosure and permitting access to a rotary shaft, said device being capable of being sealingly inserted in said opening and of being secured against the wall by securing elements, wherein it comprises two cylindrical parts assembled slidably with respect to each other, coaxially relative to the opening, a first part capable of being statically inserted in the opening, and a second part capable of being secured to the wall by the securing elements and subjected to the action of a resilient means provided between the assembled parts and tending to axially separate the second part from the wall.

2. Device wherein the resilient means is a compression spring resting on corresponding transverse faces of the first secured part and of the second movable part.

3. Device according to claim 1, wherein the first cylindrical part is mounted in axial abutment in the opening.

4. Device according to claim 3, wherein the first part has an external shoulder capable of resting against an internal shoulder forming an axial stop in said opening.

5. Device according to claim 1, wherein the first and second cylindrical parts carry around them sealing joints capable of engaging with the opening, said resilient means being provided between the sealing joints of said parts.

6. Device according to claim 1, wherein the second movable cylindrical part is mounted sealingly in part between the first secured part and the internal surface of the opening, and terminates in a radial collar or base forming a cover capable of being attached against the wall of the enclosure by the securing elements.

7. Device according to claim 1, wherein the second part is movable axially between an external shoulder on the first part and a stop part rigidly connected to the first part.

8. Device according to claim 7, wherein the stop part is screwed into a threaded passage in the first part and has a transverse ledge forming an axial stop for the movable part.

9. Gearbox forming an enclosure supporting the accessory machines of a turboshaft engine, comprising an external wall in which there is provided an opening for access to a shaft for the manual driving of a rotor of the turboshaft engine or of an accessory machine, and a device for sealing said access opening, wherein said sealing device is as defined according to claim 1.

10. Box according to claim 9, wherein the threaded holes for receiving the securing elements are provided in the external wall, around the access opening, and contain screw locking devices against which the screws rest, before tightening thereof by a specific tool, leaving the sealing joint connected to the second part at a distance from the opening in the wall.
